(19) United States
(12) Patent Application Publication
(10) Pub. No.: US 2012/0097067 A1
(43) Pub. Date: Apr. 26, 2012

(54) BIODEGRADABLE PACKAGING OF STARCH AND FIBER MADE BY EXTRUSION

(75) Inventor: Carlo Fascio, Maple (CA)

(73) Assignee: GLOBAL PATENTED TECHNOLOGIES INC., Toronto, ON (CA)

(21) Appl. No.: 13/380,400

(22) PCT Filed: Jun. 22, 2010
(86) PCT No.: PCT/CA2010/000949

§ 371 Date: Dec. 22, 2011

(30) Foreign Application Priority Data
Jun. 22, 2009 (CA) 2670216

(51) Int. Cl. C08L 3/02; B29C 47/06; B29C 47/00

(52) U.S. Cl. 106/162.9; 264/176.1; 264/211.13

(57) ABSTRACT

This invention provides both void-filling pellets and packaging board that are environmentally compatible and biodegradable. They are made from starch and cellulose fiber, potentially from recycled paper Extruded Pulp Fiber shell waste The void-filling pellets have a hard outer shell and a foamed interior. This makes them resilient to crushing, while at the same time reversibly compressible, providing protection for the item inside the packaging. The reinforced packaging board also has a hard outer shell and a foamed interior, and is reinforced by way of a multi-laminate or corrugated structure. Both the pellets and the board are made by an extrusion process that creates the outer layer and fills the interior with foam.

### TECHNICAL FIELD

This invention provides extruded pulp and starch fiber derived solely from 100% post consumer paper waste. It can be used to make a corrugated packaging product, and a protective void fill product.

### BACKGROUND

With so many goods being shipped both within and between countries at the wholesale and rectal industries, there is an enormous use of packaging products. Fragile or expensive parts are often shipped in corrugated boxes that have been void filled to suspend and cushion the product, to avoid crush and impact damage.

Corrugated board for packaging is manufactured on large high-precision corrugators. Paper is humidified by means of high-pressure steam with the aim of softening the paper fibers so that the formation of the flute and the consequent gluing will go smoothly. Humidification adds a considerable amount of water to the papers, and after the formation of the board, the humidity is removed by drying under pressure using hot plates.

Packing peanuts are a loose-fill packing material that is used as void fill within the shipping outer container. They are shaped to interlock when compressed and free flow when not compressed, and were introduced in about 1965 by Dow Chemical Corp. Originally made from 100% virgin polystyrene resin, peanuts made from 100% recycled polystyrene have been commercially available since the mid-90s. The advantage of polystyrene loosefill as a void-fill for shipping is that it is very light (usually 0.17 to 0.2 pounds per cubic foot) and easy to use.

Corrugated packaging, void fill, and similar products are sold by packaging supply companies, such as U-line® Shipping Supplies, Chicago Ill.; Geami, Morrisville N.C.; Robins Paper Bag Co. Ltd., Canterbury, Kent, UK; Nobisco Ltd, Birmingham, UK; PilloPak B.V., Eerbeek, Netherlands; Wholesale Packaging Ltd., Toronto, Canada; Doverco Inc, Montreal, Canada; and Lion Shipping Supplies Canada Inc., Mississauga, Canada.

Old corrugated containers are theoretically suitable for recycling. However, extraneous material in the scrap must be sorted out: particularly soft rubbery particles that can clog the paper maker and contaminate the recycled paper. These contaminants can originate from book bindings, hot melt adhesives, PSA adhesives from paper labels, and laminating adhesives. Styrofoam peanuts are very long-lived—when they cannot be used for repackaging, they must be recycled in the same manner as other polystyrene products.

Accordingly, there is a need for both outer packaging and void-fill products that are both biodegradable and environmentally friendly.

### DRAWINGS

FIG. 1 is a drawing of various shapes of the extruded packing pellets of this invention, comprising a hardened outer surface of pulp and starch (dark grey), filled with foam made from starch alone (light grey). This is made by a two-step extrusion process.

FIG. 2 shows another embodiment of the invention, in which both the hardened outer surface and the inner foam are a combination of pulp and starch, made by a single extrusion.

FIG. 3 shows two re-enforced biodegradable boards of the invention. In FIG. 3(A), the board contains a rigid top and bottom surface and a corrugated inside (dark grey), interpacked with foamed starch (light grey). In FIG. 3(B), instead of a corrugated interior, the profile shows open spaces made of tubes of pulp and starch. The two boards are shown in cross-section across the dimension of the extrusion used in manufacturing.

### DESCRIPTION

This invention provides both void-filling pellets and packaging board having a novel composition that allows them to fulfill the needs of packaging suppliers, in a similar manner to products already on the market. The materials of the invention constitute a substantial advance over previous materials, by virtue of the fact that they are efficiently biodegradable and environmentally compatible. They can be produced for relatively modest cost, and have a number of important attributes that will be apparent to the skilled reader.

The void-filling pellets of the invention have a harder outer shell, along with a foamed interior. This allows them to be resilient to crushing, while at the same time able to reversably compressible, thereby providing protection for the item inside the packaging. The reinforced packaging board of the invention also has a hard outer shell and a foamed interior, and is reinforced by way of a multi-laminate or corrugated structure, as described in the sections that follow. Both the pellets and the board are made by an extrusion process, which creates the outer layer and simultaneously or sequentially filling the interior with the foam.

### Starting Material

The packaging board and void fill of this invention are made from a combination of cellulose fiber and starch.

Suitable fibers for the fiber content include polymers of man-made fiber, such as polyamide nylon, polyesters, phenol-formaldehyde, polyvinyl alcohol fiber, polyvinyl chloride fiber, polyolefins, acrylic fiber, carbon fibers, polyurethane and other resin-based fibers. Cellulose fiber is preferred, being the natural structural component of the primary cell wall and connective tissue of green plants. About 33 percent of all plant matter is cellulose. For industrial use, cellulose can be obtained from wood pulp and cotton (the cellulose content of cotton is 90 percent and that of wood is 50 percent).

In particular, cellulose fiber is provided as a starting ingredient for the materials of this invention as pulp. This refers to fibrous material prepared by chemically or mechanically separating fibers from wood or fiber crops. Included are mechanical pulp, chemithermomechanical pulp, chemical pulp made by the Kraft process or by sulfite processing, and pulp recycled from industrial and consumer waste.

The source material of the pulp used for the examples shown in the figures was made from recycled paper by beating in warm water bath, and then dispersing the fibers using a blender.

Starch is a polysaccharide carbohydrate consisting of glucose monomers joined together by glycosidic bonds. Starch is produced by all green plants as an energy store. Pure starch is a white, and consists of linear amylose, helical amylose, branched amylopectin, or any of these in combination.

Depending on the plant source, starch generally contains 20 to 25% amylose and 75 to 80% amylopectin. Each plant species has a unique starch granular size: rice starch is relatively small (about 2 μm), potato starch have larger granules (up to 100 pm).

A suitable source of starch for use in this invention is industrial corn starch. This can be obtained from National Starch and Chemical Company (NACAN), Brampton, Ontario, now owned by Akzo Nobel N.V. They provide wet-end starch additives to improve strength and productivity in acid, neutral or alkaline paper and board production, and surface starch strength and printability additives for paper and board, such as uncoated office papers, food packaging papers and uncoated book papers.

Some modified starches can also be used. The following list of modified starches is classified by the system established by the International Numbering System for Food Additives (INS):
1401 Acid-treated starch
1402 Alkaline-treated starch
1403 Bleached starch
1404 Oxidized starch
1405 Starches, enzyme-treated
1410 Monostarch phosphate
1411 Distarch glycerol
1412 Distarch phosphate esterified with sodium trimetaphosphate
1413 Phosphated distarch phosphate
1414 Acetylated distarch phosphate
1420 Starch acetate esterified with acetic anhydride
1421 Starch acetate esterified with vinyl acetate
1422 Acetylated distarch adipate
1423 Acetylated distarch glycerol
1440 Hydroxypropyl starch
1442 Hydroxypropyl distarch phosphate
1443 Hydroxypropyl distarch glycerol
1450 Starch sodium octenyl succinate

Other materials can be used in the pulp slurry or during the process as desired: for example, one or more surfactants, strengtheners, binders, dispersants, pro- or anti-microbials, and so on. However, such ingredients are often not necessary, in which case they can be left out to promote the pro-environmental profile of the product.

### Manufacturing Process

The packaging board and void fill of this invention are made by way of extrusion. A suspension or slurry of cellulose or other fiber and starch is first prepared in a liquid medium (usually water) at a ratio of between about 2:1 and 10:1, depending on the hardness desired, typically about 3:1. The slurry is then concentrated by a suitable density by removing water by centrifugation. Another benefit of the extrusion process is that the pressure can have the effect of gelatinizing the starch.

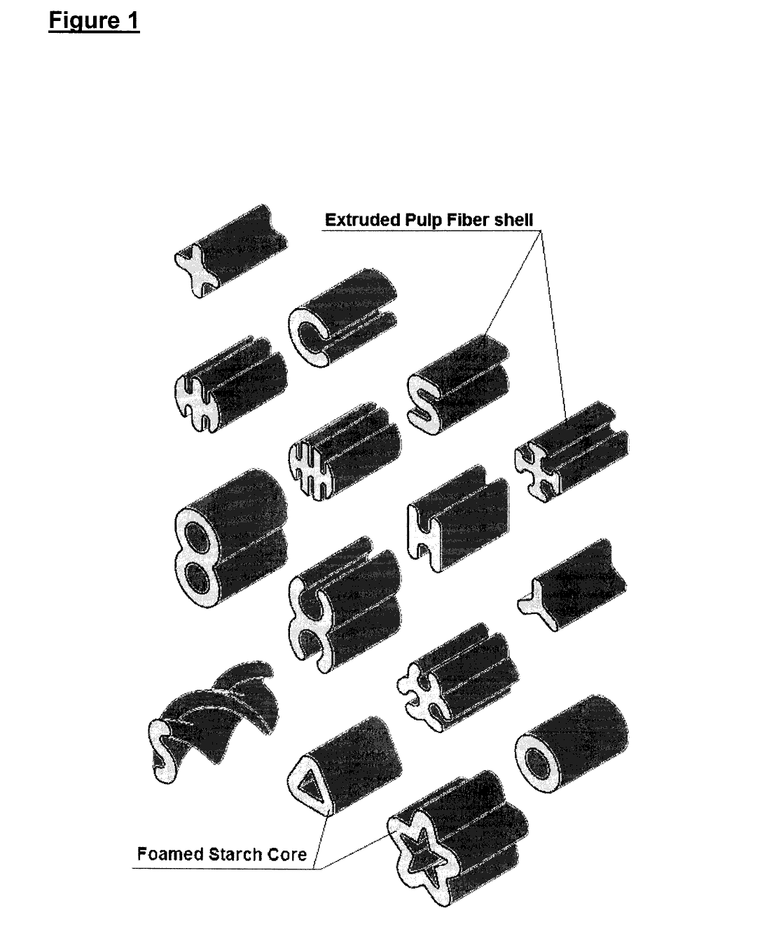

To form the cross-sections for the packing pellets shown in FIG. 1, the concentrated slurry is pushed or drawn through a die of the desired cross-section, leaving the finished parts with an excellent surface finish. In a two-step extrusion, a rigid shell is first formed with the fiber-starch combination, allowing the water from the slurry to escape by out-gassing. The product is then pressed through a second extrusion with a pure and less concentrated starch suspension in water, injected into the interior spaces between the shell. While the material is under pressure, it is heated above atmospheric boiling temperature (about 300° F.), staying in the liquid state due to the pressure. As the material comes out of the extrusion mold, it re-equilibrates with atmospheric pressure, causing water in the suspension to vaporize. This creates both a foaming and drying action, which results in the outer shell (shown in the figure as dark grey) being filled throughout the interior with foamed starch (shown as light grey). In some of the extrusions like the O-shape, the 8-shape, the triangle and the star, there is one or more internal void spaces running the length of the extrusion, formed by an interior wall of the same material as the outer shell.

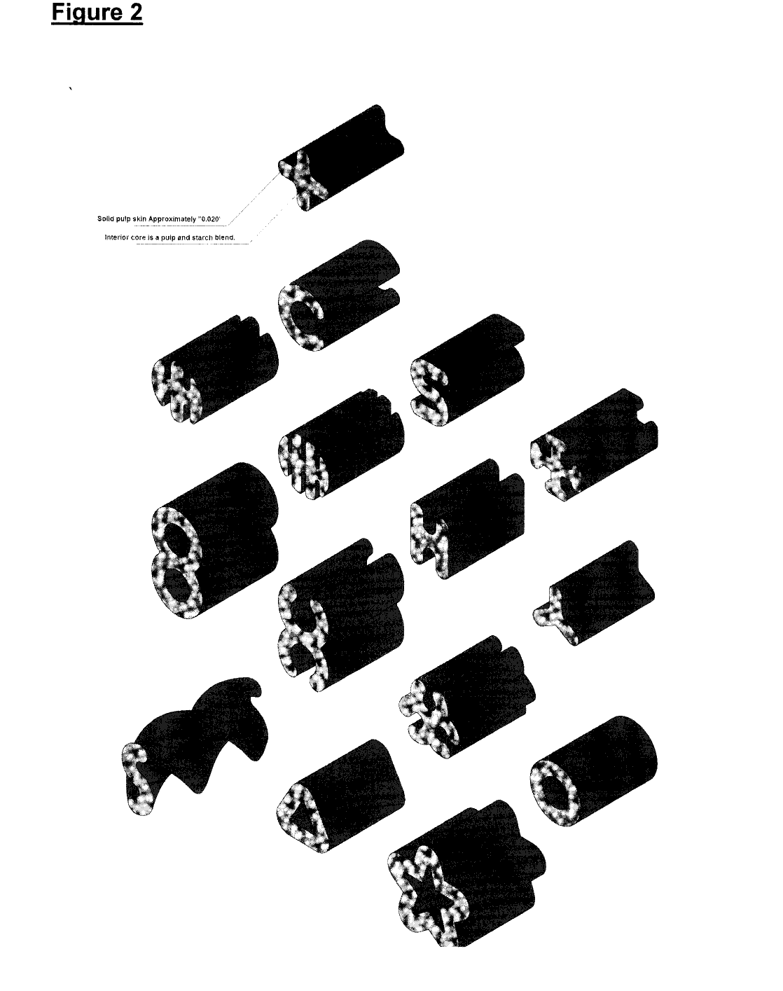

An alternative method is depicted in FIG. 2. The process is similar, except that both the outer shell and the inner foam are made of a combination of fiber and starch. By conducting an extrusion at about 300° F., the outer shell and inner foam are crated in essentially the same step.

Continuous extrusion will generate pieces that are generally too long for purposes of void-fill packing. Accordingly, sections of between 1 and 10 cm are generated during manufacturing either by using a semi-continuous process, or by taking the product of a continuous extrusion and cutting it into pieces of an appropriate size. Optionally, the ends of the cut pieces can be coated with an outer shell of fiber and starch or other suitable material.

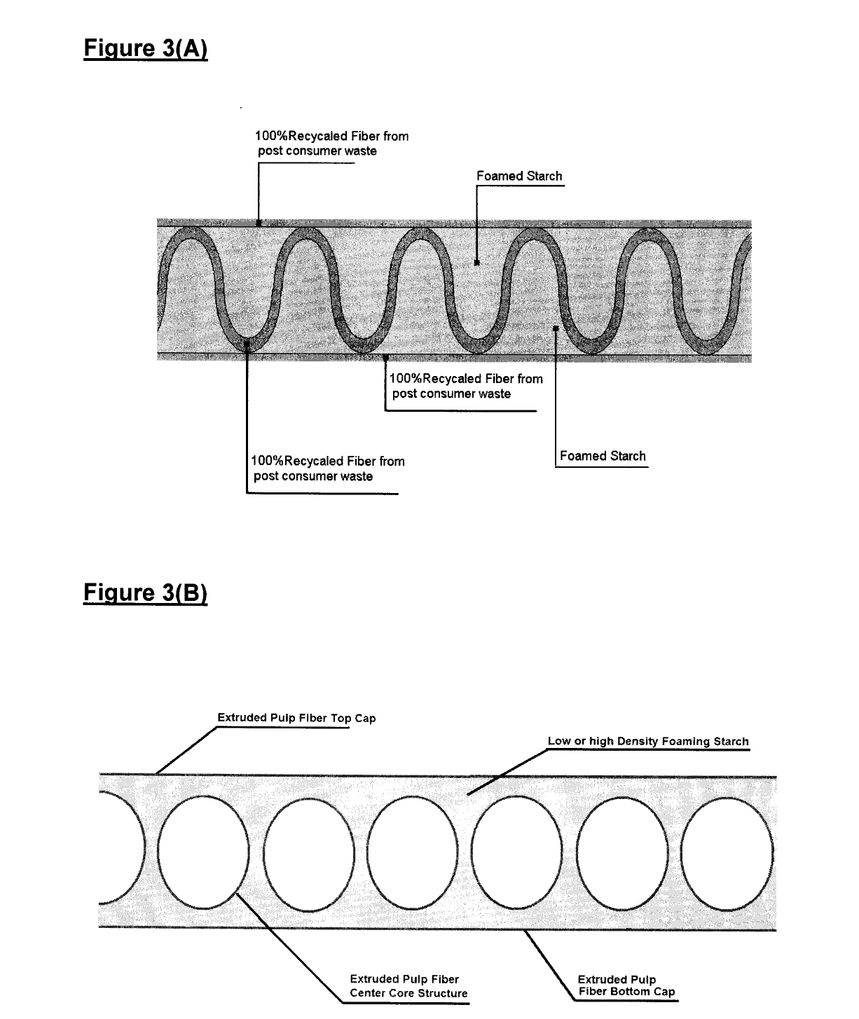

The reinforced packing board of this invention, as shown in FIG. 3, is also made by extrusion. FIG. 3(A) shows the cross-section of the board head-on in the dimension orthogonal to the mold. The extrusion mold forms the top and the bottom shell, and the internal corrugated layer that provides the enforcement (shown in the figure as dark grey). A second extrusion above atmospheric boiling temperature (about 300° F.) is used with a starch solution, to produce the foamed starch filler that occurs in the corrugated spaces between the top and bottom shell. In FIG. 3(B), a similar process is used with a different mold, resulting in an internal structure of columnar voids separated from the foamed packing by way of a plurality of inner columnar shells.

The cushioning properties, flexibility and the day-to-day durability of the materials of this invention can be adjusted to suit the purpose that the user may have in mind by altering the ratio of fiber to starch, by changing the plant source of the starch to one having different properties, and by making adjustments to the shape of the various components: such as the thickness of the outer and interior shell, and the degree of foaming of the interior.

### Uses

Following manufacture, the materials of this invention can be placed into service in the same manner as conventional packing material. Reinforced packing board of this invention may be pre-cut or folded into boxes or other containers suitable for packaging and shipment. For shipping heavy, fragile, or unusually shaped items, they can be suspended above the bottom and surrounded with the void-fill pellets, to prevent the contents from shifting during the transport process, and cushioning against impact damage. The materials of this invention may be used for other purposes where strong yet biodegradable boarding and pellets are suitable. For example, the biodegradable boarding can be used in some circumstances for temporary signage (using environmentally friendly vegetable inks), or for disaster relief housing that is easily disposable after the housing emergency has passed.

The materials of this invention are designed to be “biodegradable”, which means they readily degrade when exposed to a natural environment out-of-doors: particularly water. The water will soon remove the starch, leaving the fiber in a non-compacted form. This can occur within a few days or weeks of water exposure. When the fiber is made of cellulose, it is also a natural product, essentially the same as the cellulose made by plants, and degradable by the same process. Since voids are created by loss of the salt, degradation is rapid. Thus, the user can simply place the material in a water holding tank or spread it on their lawn, and it will disappear into non-visible particulates in as little as one major precipitation event, usually within a month or less. The user is cautioned to ensure compatibility at the site where the material is disposed of by checking local regulations and starting with a small test sample, in case there are plants, animals, or other environmental features near by with a special sensitivity to any of the ingredients or byproducts of the degradation.

The materials described in this disclosure can be effectively modified by routine optimization without departing from the spirit of the invention embodied in the claims that follow.

1-20. (canceled)

21. Biodegradable pellets for use as a void fill in packaging, consisting essentially of cellulose fiber and starch.

22. The biodegradable pellets of claim 21, comprising a solid shaped outer surface and a foamed interior.

23. The biodegradable pellets of claim 22, wherein the hard outer surface is made of cellulose fiber and starch, and the interior is made of foamed starch.

24. The biodegradable pellets of claim 22, wherein the hard outer surface and the foamed interior are both made of fiber and starch.

25. The biodegradable pellets of claim 21, further comprising one or more interior voids lined with a hard surface made of cellulose fiber and starch.

26. The biodegradable pellets of claim 21, wherein the cellulose fiber is obtained from pulp made from recycled paper waste.

27. The biodegradable pellets of claim 21, shaped according to any of the panels shown in FIG. 1.

28. A method for producing the biodegradable pellets of claim 21, comprising extruding a suspension of fiber and starch through a mold shaped in accordance with a profile of the pellets.

29. The method of claim 28, further comprising extruding a suspension of fiber and starch through a mold to form an outer surface of the pellets, and then filling the interior of the pellets with foamed starch.

30. The method of claim 29 wherein the extruding through a mold and the filling of the interior are performed as a single step.

31. Biodegradable multi-layered board for use in packaging, consisting essentially of cellulose fiber and starch.

32. The biodegradable board of claim 31, comprising a solid shaped outer surface and a foamed interior.

33. The biodegradable board of claim 32, wherein the hard outer surface is made of cellulose fiber and starch, and the interior is made of foamed starch.

34. The biodegradable board of claim 32, comprising a corrugated interior reinforcement made of cellulose fiber and starch.

35. The biodegradable board of claim 32, comprising an interior reinforcement made of cellulose fiber and starch configured to form a columnar space through the boards.

36. A method for producing the biodegradable board of claim 32, comprising extruding a suspension of fiber and starch through a mold to form an upper and a lower surface, and then filling space in between with foamed starch.

37. The biodegradable board according to claim 32, for use in a method of packaging an item.

38. The biodegradable void-filling particles according to claim 21 for use in protecting an item during shipment.

39. The biodegradable pellets according to claim 21, wherein the pellets can be disposed of by placing them in a place where they will be exposed to moisture.

40. The biodegradable board according to claim 32, wherein the board can be disposed of by placing it in a place where it will be exposed to moisture.
